(19) United States
(12) Patent Application Publication
(10) Pub. No.: US 2016/0125239 A1
(43) Pub. Date: May 5, 2016

(54) Systems And Methods For Secure Iris Imaging

(71) Applicant: Delta ID Inc., Fremont, CA (US)

(72) Inventors: Oleksiy Danikhno, Mountain View, CA (US); Alexander Ivanisov, Newark, CA (US); Salil Prabhakar, Fremont, CA (US)

(21) Appl. No.: 14/527,918

(22) Filed: Oct. 30, 2014

(51) Int. Cl. G06K 9/00; G06F 21/32; H04N 5/232

(52) U.S. Cl. CPC G06K 9/00604; H04N 5/23293; H04N 5/23296; G06K 9/00617; G06F 21/32

(57) ABSTRACT

The invention provides methods, systems and computer program products for secure iris image processing. The invention involves acquiring a first image of a first field of view corresponding to an iris camera. A first set of image information defining the first image is received at a processor implemented first high security operating environment, which first set of image information includes a second sub-set of image information relevant for iris feature extraction and/or comparison. A second image of the first field of view corresponding to the iris camera is rendered on a display, which second image is defined by a third set of image information such that the third set of information excludes the second sub-set of image information.

### FIELD OF INVENTION

The invention relates to systems and methods for secure processing of images of a subject's eye for biometric recognition.

### BACKGROUND

Methods for iris recognition implement pattern-recognition techniques to compare acquired images of a subject's iris against previously stored images of irises, to determine or verify identity of the subject. A digital feature set corresponding to an acquired iris image is encoded based on the image, using mathematical or statistical algorithms. The digital feature set or template is compared with databases of previously encoded digital templates (stored feature sets corresponding to previously acquired iris images), for locating a match and determining or verifying identity of the subject.

Systems for iris recognition typically comprise an imaging apparatus for capturing an image of a subject's iris(es) and an image processing apparatus for comparing the captured image against previously stored iris image information. The imaging apparatus and image processing apparatus may comprise separate devices, or may be combined within a single device.

While iris recognition systems have been previously available as dedicated devices, it is increasingly desirable to incorporate iris recognition capabilities into multi-capability devices having inbuilt cameras, including electronic devices, computing devices, handheld devices or mobile devices such as mobile communication devices or mobile computing devices, such as for example, mobile phones, smart phones, personal digital assistants, tablets, laptops, wearable computing devices or even automobiles, or automotive components and accessories having inbuilt cameras.

Although use of such devices for iris recognition purposes is convenient and cost-effective, unsecured processing of iris images and extraction of iris texture information within such devices presents serious security concerns and potential for identity theft.

A first security concern arises from the threat of viruses, malware or other malicious software which may be present within a device and may be used to misappropriate images of a subject's iris, or iris texture information extracted from such images, or digital feature sets encoded based on such images, which misappropriated data or information may thereafter be used to impersonate a subject.

A second security concern arises in connection with visual feedback mechanisms implemented within a device for ensuring that a subject's eye is appropriately positioned for iris imaging.

Since operation of an iris camera or other image acquisition device for iris image capture purposes is usually carried out by the subject undergoing iris image capture, some form of feedback is required to enable the subject to correctly position the device relative to the subject's eye. Correct positioning ensures that the subject's iris is appropriately positioned within the iris camera's field of view. Visual feedback for positioning may be provided by displaying (on a display device), real-time or near-real-time images captured by the iris camera. A subject may adjust the position of the iris camera/image acquisition device relative to an eye, until an image of the entire iris (or substantially the entire iris) is displayed on the display device—which image display confirms that the subject's iris is positioned appropriately within the iris camera's field of view. In cases where the image acquisition device is an inbuilt camera within a computer, or within a handheld device, a display screen of the computer or handheld device serves as the display device for displaying iris images.

The above method for providing visual feedback for positioning a subject's iris presents a security risk—since in displaying an image of the iris, iris information corresponding to the displayed image is is vulnerable to misappropriation by photographic or video acquisition of the iris image rendered on the device display.

It is therefore an objective of the present invention to provide secure methods and systems for iris image acquisition and processing.

### SUMMARY

The invention provides methods, systems and computer program products for secure iris image processing.

The method for secure iris image processing in accordance with the present invention involves acquiring a first image of a first field of view corresponding to an iris camera. A first set of image information defining the first image is received at a processor implemented first high security operating environment, which first set of image information includes a second sub-set of image information relevant for iris feature extraction and/or comparison. A second image of the first field of view corresponding to the iris camera is rendered on a display, which second image is defined by a third set of image information such that the third set of information excludes the second sub-set of image information.

In accordance with the present invention, the third set of information defining the second image may be received at a processor implemented second normal security operating environment, for rendering the second image on the display.

The processor implementing the first high security operating environment may be configured to operate in a first security state, and the processor implementing the second normal security operating environment may be configured to operate in a second security state, such that the first security state is more secure than the second security state.

Responsive to a part of the subject's iris being positioned within the first field of view corresponding to the iris camera, the second image rendered on the display may include an image of said part of the iris positioned within the first field of view.

In a method embodiment, the third set of image information may be generated by applying at least one image processing function to the first set of image information.

In a particular embodiment of the method, the first image of the first field of view may be acquired by the iris camera, while the second image may be acquired by a feedback camera having a second field of view—such that at least part of the first field of view intersects at least part of the second field of view. Intersection of the first field of view and the second field of view may define an intended region for positioning of a subject's eye for optimal iris image capture. The intersection of the first field of view and second field of view may include a region defined by intersection of the first field of view and depth of focus of the iris camera.

In a specific embodiment of the method, the first image and the second image may be simultaneously acquired by the iris camera and the feedback camera respectively. In another embodiment, the second field of view may be wider than the first field of view.

The iris camera of the present invention may in an embodiment have improved iris imaging characteristics in comparison to the feedback camera. The configuration of the iris camera may differ from configuration of the feedback camera in terms of at least one of pixel resolution, depth of focus, and optical filters.

In an embodiment the iris camera may be configured to detect image characteristics based on received wavelengths within at least one of the infrared and near infrared spectrums. The feedback camera may be configured to include an optical assembly comprising at least one optical filter for preventing infrared or near infrared wavelengths from being detected by an image sensor.

In a method embodiment of the present invention, the first image is acquired by an iris camera having a first field of view, and the second image is generated by cropping a third image acquired by a feedback camera having a second field of view—wherein at least part of the first field of view intersects at least part of the second field of view. The cropped image may include image information corresponding to a region defined by intersection of the first field of view and the second field of view.

The invention additionally provides a system for secure iris image processing. The system comprises an iris camera, a processor and a display. The iris camera may be configured to acquire a first image of a first field of view corresponding to the iris camera. The processor may be configured to implement a first high security operating environment, and to receive at the first high security operating environment, a first set of image information defining the first image, such that the first set of image information includes a second sub-set of image information relevant for iris feature extraction. The display may be configured for rendering a second image of the first field of view corresponding to the iris camera—such that the second image is defined by a third set of image information, and the third set of information excludes the second sub-set of image information.

In an embodiment, the third set of information defining the second image may be received at a processor configured to implement a second normal security operating environment, for rendering the second image on the display.

The system of the present invention may further comprise a feedback camera configured to have a second field of view and to acquire the second image, wherein at least part of the first field of view intersects at least part of the second field of view. This camera and the feedback camera may simultaneously acquire the first image and the second image respectively. In an embodiment, the iris camera may have improved iris imaging characteristics in comparison to the feedback camera.

In a particular embodiment, configuration of the iris camera may differ from configuration of the feedback camera in terms of at least one of pixel resolution, depth of focus, and optical filters. The feedback camera may include an optical assembly comprising at least one optical filter for preventing infrared or near infrared wavelengths from being detected by an image sensor.

In an embodiment, the intersection of the first field of view and second field of view may include a region defined by intersection of the first field of view and depth of focus of the iris camera.

In a specific system embodiment, the processor may be configured to generate the second image by cropping a third image acquired by a feedback camera having a second field of view—such that at least part of the first field of view intersects at least part of the second field of view.

The invention additionally provides a computer program product for secure iris image processing. The computer program product may comprise a non-transitory computer usable medium having a computer readable program code embodied therein, which computer readable program code comprising instructions for (i) acquiring a first image of a first field of view corresponding to an iris camera (ii) receiving at a processor implemented first high security operating environment, a first set of image information defining the first image, wherein the first set of image information includes a second sub-set of image information relevant for iris feature extraction (iii) rendering on a display, a second image of the first field of view corresponding to the iris camera, wherein the second image is defined by a third set of image information, and wherein the third set of information excludes the second sub-set of image information.

### BRIEF DESCRIPTION OF THE ACCOMPANYING DRAWINGS

FIG. 1 illustrates an architecture 100 configured to implement two isolated operating environments.

FIG. 2 illustrates an iris camera having a finite and fixed field of view.

FIG. 3 is a functional block diagram of a device configured for secure iris recognition.

FIGS. 4 and 5 illustrates methods for ensuring security of iris information within a device of the type illustrated in FIG. 3.

FIGS. 6A, 6B and 8B illustrate imaging apparatuses in accordance with the present invention.

FIGS. 7 and 8A illustrates a method of image acquisition and image processing.

FIG. 9 illustrates an exemplary system in accordance with the present invention.

### DETAILED DESCRIPTION

The present invention is directed to secure methods and systems for iris image acquisition and processing. In an embodiment the system of the present invention includes an device having an iris based recognition system implemented therein.

The methods and systems of the present invention rely on an image processing arrangement including two operating environments. A first high security operating environment functions in a secure state and is utilized for services that require enhanced security. A second normal security operating environment functions in a normal state (which is less secure than the secure state) and is utilized for services that do not require enhanced security. For example, in a device comprising a mobile phone, normal security services, such as making a phone call or using entertainment applications may be implemented within the normal security operating environment, whereas high security services such as online credit card transactions or banking transactions may be implemented within the high security operating environment. Preferably the two operating environments are isolated from each other.

The dual operating environments may be implemented based on one or more processors having an architecture configured to implement the secure operating environment and the normal operating environment. The architecture may provide enhanced security features and protection to processor(s) and memory operating within the high security operating environment, and may segregate secure data and normal data to be separately processed by the high security operating environment and the normal security operating environment respectively.

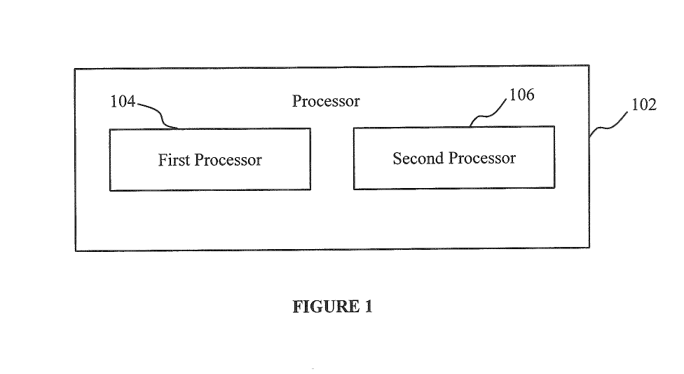

FIG. 1 illustrates an architecture 100 configured to implement two isolated operating environments. The processor 102 may include a first processor 104 for implementing the high security operating environment and a second processor 106 for implementing the normal security operating environment. The first processor 104 may be used to execute services or operations requiring high security, while the second processor 106 may be used to execute services or operations requiring normal security. First processor 104 may additionally be protected from outside access and may also be protected from access or control initiated by second processor 106. It would be understood that the first processor 104 and the second processor 106 may comprise physically separate processors, or alternatively may both comprise logical processing units within a single physical processor. While not illustrated in FIG. 1, it would be understood that the processor 102 (or the first and second processors 104 and 106) may be connected to and may communicate with one or more of memory, storage, input unit(s), output unit(s) and communication interface(s).

TrustZone hardware architecture developed by ARM provides normal security services and high security services using a single physical processor core. To isolate sensitive data from security threats, the single processor core of the TrustZone hardware switches between a normal security state and a high security state to respectively provide a normal operating environment and a secure operating environment in a time-sliced manner, and corresponding hardware resources are design-dedicated to one of the normal security operating environment and the high security operating environment.

The present invention may be implemented based on TrustZone hardware architecture or on any other architecture capable of implementing and maintaining two operating environments having respectively differing levels of security, as described above.

While earlier biometric identification methods and systems (such as for example fingerprint based identification) implemented on electronic devices have been known to use TrustZone hardware or equivalent protections for securing sensitive biometric information, such earlier systems do not address security concerns particular to iris based biometric recognition.

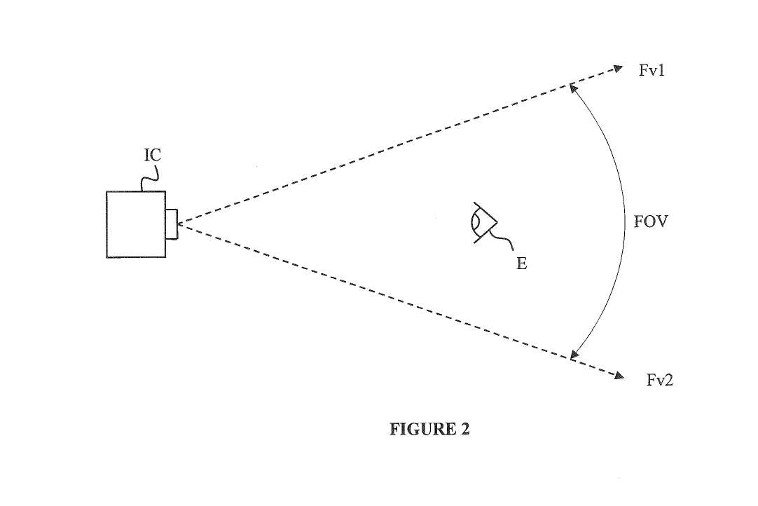

It will be understood that implementing iris based biometric recognition systems in electronic devices requires a subject's eye(s) to be positioned within a defined field of view of an iris camera, such that an image of the entire iris (or substantially the entire iris) is acquired for feature extraction and comparison. FIG. 2 illustrates an iris camera IC having a finite and fixed field of view FOV (i.e. the volume of inspection capable of being captured on the camera's image sensor). In FIG. 2, field of view FOV is the region defined by dashed lines Fv1 and Fv2 and a subject's eye E requires to be positioned within said field of view FOV to ensure that an image of the entire iris imaging is acquired for feature extraction and comparison.

As discussed above, a device display associated with an imaging apparatus or other iris camera may be configured to provide visual feedback to enable a subject to position the imaging apparatus correctly so that an iris is appropriately positioned within the field of view. The visual feedback comprises displaying real-time images captured by the iris camera on the display—thereby enabling an operator or subject to adjust the position of an eye relative to the imaging apparatus until the subject's iris is positioned appropriately within the imaging apparatus' field of view.

The above configurations for iris image capture and visual feedback creates security risks—even where image processing apparatuses employs a high security operating environment for image processing. This is for the reason that, in displaying an image of the subject's iris on a display device, iris information corresponding to the displayed image is communicated beyond the boundaries of the high security operating environment, where it is vulnerable to:
software based attacks and misappropriation, and
misappropriation by photographic or video acquisition of the iris image displayed on the device display.

The present invention addresses these security concerns by isolating sensitive iris image information within the high security operating environment, while releasing non-sensitive iris image information to the normal security operating environment and to the display device for visual feedback purposes.

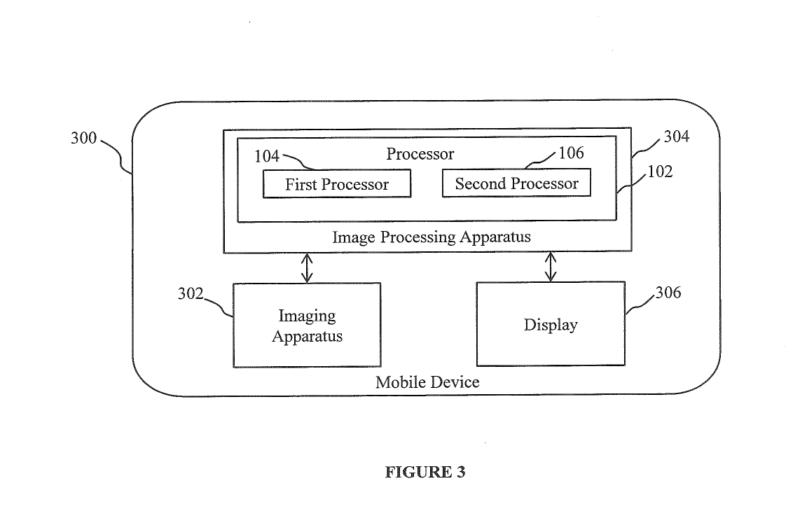

FIG. 3 is a functional block diagram of a device 300 configured for secure iris recognition, comprising an imaging apparatus 302, an image processing apparatus 304 and a display 306. Image processing apparatus 304 comprises processor 102 (see FIG. 1)—which processor 102 is configured to implement a high security operating environment and a normal security operating environment, each isolated from the other. Images processed by image processing apparatus 304 may in an embodiment be transmitted to display 306 for display to a user or operator of the imaging apparatus or biometric device.

In operation, imaging apparatus 302 acquires an image of the subject's iris and transmits the image to image processing apparatus 304. The image captured by imaging apparatus 302 may be a still image or a video image. Image processing apparatus 304 may thereafter analyse the acquired image frame(s) and compare the corresponding digital feature set with digital templates encoded and stored based on previously acquired iris images, to identify the subject, or to verify the identity of the subject.

Device 300 may include other components not illustrated in FIG. 3, including components for extracting still frames from video images, for processing and digitizing image data, for enrollment of iris images (the process of capturing, and storing iris information for a subject, and associating the stored information with that subject) and comparison (the process of comparing iris information acquired from a subject against information previously acquired during enrollment, for identification or verification of the subject's identity), and for enabling communication between components of device 300. The imaging apparatus, image processing apparatus and other components of device 300 may comprise independent or separate devices, or may be combined within a single device.

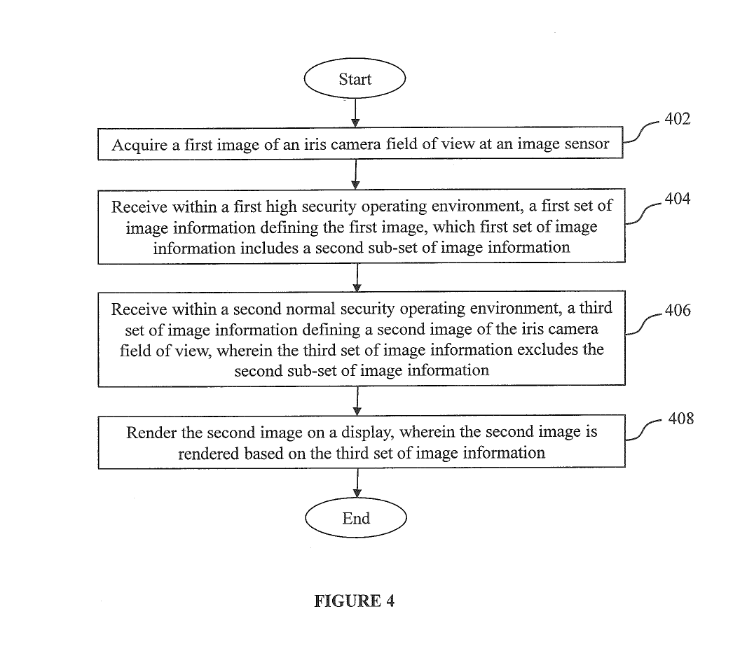

FIG. 4 illustrates a method according to the present invention, for ensuring security of iris information within a device of the type illustrated in FIG. 3.

Step 402 of FIG. 4 comprises acquiring a first image of an iris camera field of view. The first image may be acquired at an iris camera image sensor. At step 404, a first set of image information defining the first image is received within a first high security operating environment within an image processing apparatus. The first set of image information may be communicated from the iris camera image sensor to the first high security operating environment. In another embodiment, an image processor controlling the iris camera image sensor may be part of the first high security operating environment, and image information defining the image acquired by the iris camera image sensor may be parsed by said image processor.

The first set of image information received at step 404 includes a second sub-set of image information, which second sub-set of image information enables or is relevant for iris feature extraction or iris image recognition. In an embodiment, the second sub-set of image information may include information which enables or is relevant for recording or rendering iris texture information acquired by the iris camera image sensor.

Step 406 comprises receiving within a second normal security operating environment of the image processing apparatus, a third set of image information defining a second image of the iris camera field of view, wherein the third set of image information excludes the second sub-set of image information.

By ensuring that the second sub-set of image information (which enables or is relevant for iris feature extraction or image recognition) is excluded from the image information received within the second normal security operating environment (and is accessible only within the first high security operating environment), the method ensures that information which enables or is relevant for iris feature extraction or iris image recognition is protected from attempts to misappropriate, and from software attacks.

Step 408 subsequently renders the second image on a display device (such as for example mobile device display or any other electronic display device). Since the second image is an image of the iris camera field of view, said second image may be used by an operator as visual feedback to enable positioning of an eye/iris within the iris camera's field of view.

Additionally, since the second image is defined by the third set of information, it correspondingly excludes the second sub-set of information that enables or is relevant for iris feature extraction or iris image recognition. Step 408 accordingly ensures that the displayed second image cannot be used for misappropriating information that is relevant for iris feature extraction or iris image recognition—for example by photography or video acquisition of an iris image rendered on the display.

It would be understood that the step of generating a third set of image information defining a second image of the iris camera field of view can be achieved in multiple ways.

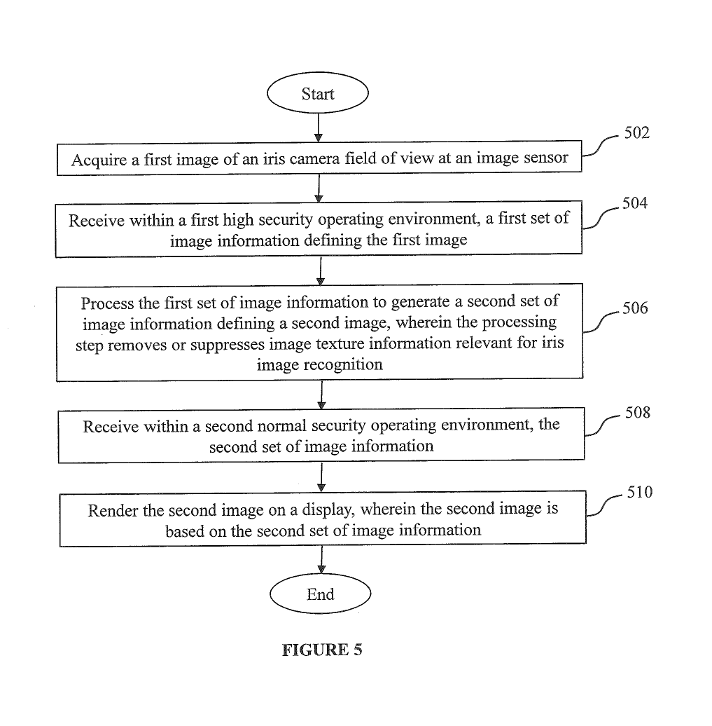

FIG. 5 illustrates a specific embodiment of the method illustrated in FIG. 4, wherein a third set of information and a corresponding second image of the iris camera field of view are generated by applying image processing techniques to the first set of information defining the first image of the iris camera field of view. As discussed below, appropriate image processing techniques may be selected to ensure that the third set of information and corresponding second image exclude information relevant for iris feature extraction or iris image recognition.

At step 502, a first image of an iris camera field of view is acquired at an image sensor. Step 504 comprises receiving a first set of image information defining the first image, within a first high security operating environment of the image processing apparatus.

Step 506 comprises processing the first set of image information, to generate a second set of image information defining a second image of the iris camera field of view. The processing step of step 506 removes, suppresses or otherwise alters image texture information that enables or is relevant for iris feature extraction or iris image recognition.

In an embodiment of the method, image processing step 506 removes all or part of iris texture information from the first set of image information, to generate the second set of image information. Image processing step 506 may be implemented entirely within the first high security operating environment to ensure that: (i) the first image of the iris camera field of view (ii) the first set of image information defining said first image and (iii) image texture information that enables or is relevant to iris feature extraction or iris image recognition—are not communicated to or otherwise accessible outside of the first high security operating environment.

Step 508 comprises receiving within the second normal security operating environment of the image processing apparatus, the generated second set of image information. Based on the generated second set of image information, step 510 renders a corresponding second image on a display. Since the second set of information and corresponding second image excludes image texture information that enables or is relevant for iris feature extraction or iris image recognition, sensitive iris information remains protected despite the second set of image information and the second image being exposed to the normal security operating environment and/or a display device.

Image processing at step 506 may include processing in accordance with any one or more image processing techniques selected to ensure that the second set of image information and corresponding second image excludes information relevant for iris feature extraction or iris image recognition. Relevant image processing techniques may include any one or more digital filters or image processing functions selected to ensure that at least a part of image texture information which enables or is relevant for iris feature extraction or iris image recognition from the first image is “filtered out” or is appropriately suppressed or altered when generating the second image.

Exemplary filters or functions that may be configured for pixelating, blurring, diffusing, embossing, extruding, fragmenting, lens-flaring, pointillizing, solarizing, tilting, crystalizing, faceting, rippling, shearing, spherizing, shading, re-coloring, de-coloring, distorting, magnifying, crazing introducing droplet effects, introducing mosaic patterns, twirling effects, wave effects, or zigzagging.

In a particular embodiment, the first image or corresponding first set of image information is subjected to one or more of (i) a sketching filter—which generates a sketch of the acquired first image (for example, using edge detection algorithms) (ii) a cartoonizing filter—which combines edge detection algorithms with a predefined (and preferably primitive) color quantization algorithm, (iii) a cartoonizing bilateral filter—which may use both local special and range information to blur the image but preserve edges, (iv) image conversion filters—which apply a predefined set of rules to vary one or more of color, texture and brightness of pixels within an image, which variation is responsive to the detected original color, texture and brightness of pixels and (v) “painting” filters—which divide a digital image into a plurality of working regions, and apply a predefined or selected painting effect to pixels within each working region. By applying appropriate filters or functions to the first image, image processing step 506 ensures at least some part of image texture information that enables or is relevant to iris feature extraction or iris image recognition is obscured, suppressed, omitted or excluded in the second image and corresponding second set of image information.

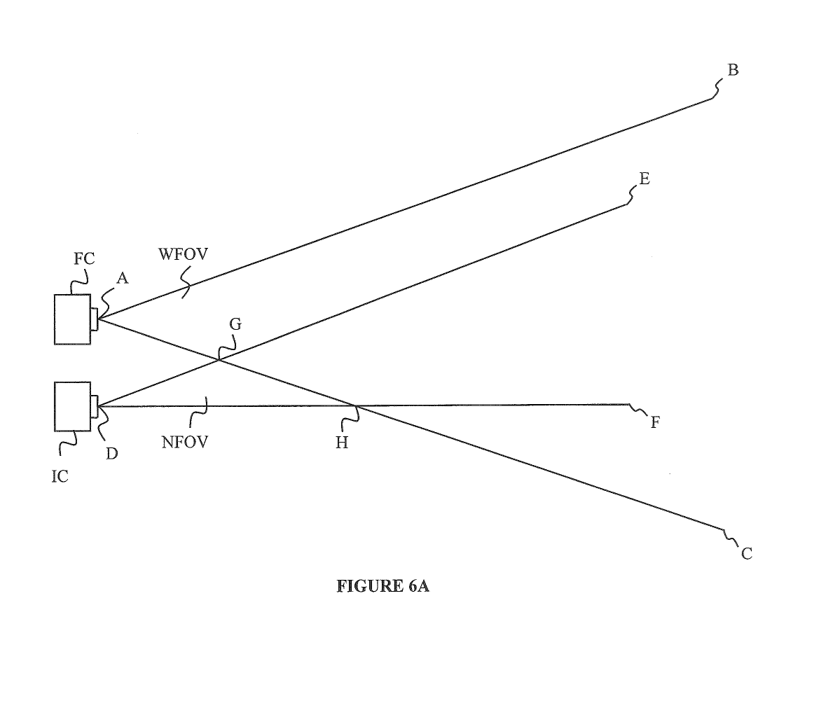

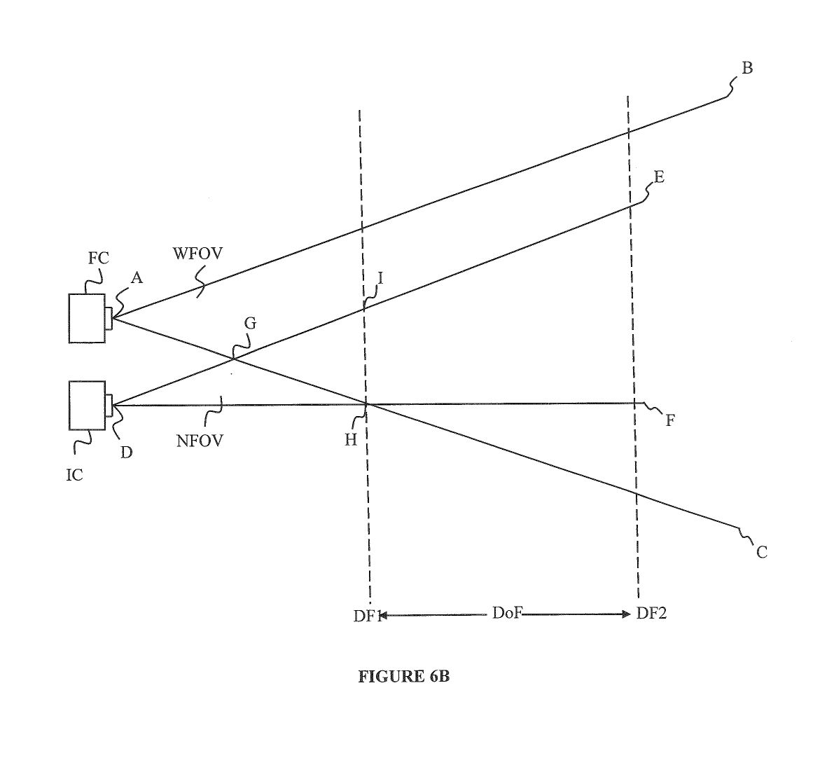

FIGS. 6A and 6B illustrate imaging apparatuses configured to implement an alternative embodiment of the method more generally described in connection with FIG. 4. The imaging apparatus of FIG. 6A illustrates a dual camera arrangement comprising iris camera IC and feedback camera FC. Field of view of iris camera IC comprises the region within lines DE and DF, while field of view of feedback camera FC comprises the region within lines AB and AC. The iris camera IC and feedback camera FC are configured and positioned such that field of view of iris camera IC falls substantially (or entirely) within field of view of feedback camera FC. In an embodiment of the invention, iris camera IC may be configured to have a narrow field of view (NFOV) while feedback camera FC may be configured to have a wide field of view (WFOV). This configuration enables the two cameras to be positioned relative to each other such that the narrow field of view NFOV of iris camera IC is located substantially (or entirely) within the wide field of view WFOV of feedback camera FC. As illustrated in FIG. 6A, excluding region DGH, the remaining area within narrow field of view NFOV of iris camera IC is located within wide field of view WFOV of feedback camera FC.

The respective configurations of iris camera IC and feedback camera FC are selected to provide differing imaging abilities, such that iris camera IC has improved iris imaging characteristics in comparison to feedback camera FC. In an embodiment, iris camera IC is configured to acquire a set of image texture information characteristics that feedback camera FC is (i) incapable of acquiring or (ii) configured to exclude or omit during image acquisition—which image texture information characteristics enable or are relevant to iris feature extraction or iris image recognition. In an embodiment, the difference in imaging ability between iris camera IC and feedback camera FC may be achieved in terms of differences in one or more of pixel resolution, depth of focus, optical assemblies, and optical filters.

In a particular embodiment, feedback camera FC may be provided with an IR cut filter or other appropriate optical filter, configured to prevent the corresponding image sensor from detecting infrared wavelengths and/or near infrared wavelengths, while iris camera IC may be configured to detect and image objects based on wavelengths within the infrared or near infrared spectrum. Since wavelengths within the infrared or near infrared spectrum have been found to be particularly effective in conveying iris texture information, the IR cut filter disposed on feedback camera FC ensures that the image acquired by feedback camera FC does not include corresponding iris texture information conveyed within the infrared or near infrared spectrum, whereas the same iris texture information may be acquired by iris camera IC based on detected radiations within the infrared or near infrared wavelength.

Since iris camera IC and feedback camera FC have overlapping fields of view, both imaging apparatuses would capture images of a subject's iris that is positioned within a region defined by the overlapping fields of view. However as a consequence of their differing configurations, in imaging a subject's iris positioned within the overlapping fields of view, iris camera IC would detect and acquire more image texture information that enables or is relevant to iris feature extraction or iris image recognition, when compared with the image texture information detected and acquire by feedback camera FC. In an embodiment of the invention, feedback camera FC may be configured to exclude or omit acquisition of certain image texture information that enables or is relevant to iris feature extraction or iris image recognition, which image texture information is simultaneously acquired by iris camera IC.

FIG. 6B illustrates a more particular embodiment of the imaging apparatus generally illustrated in FIG. 6A, wherein iris camera IC has a depth of field DOF—which depth of field DOF defines the region within which a subject's iris would appear acceptably sharp and in sufficient detail for the purposes of iris image capture. Positioning a subject's iris within an intersection region of the iris camera's field of view and depth of field ensures that the resulting image of the subject's iris is likely to be acceptable or optimal for iris recognition purposes. In FIG. 6B, depth of field DOF of iris camera IC is identified as the region between dashed lines Df1 and Df2, and the intersection between the depth of field DOF and iris camera field of view is defined by region HIEF. Positioning of a subject's eye within region HIEF would ensure that an image of the subject's iris acquired by iris camera IC would be of sufficient image quality for the purposes of iris image capture and recognition.

It will be noted from FIG. 6B that the dual camera arrangement is configured such that the intersection region HIEF (i.e. the region within which a subject's iris requires to be positioned for optimal iris image capture) falls entirely within the boundaries of the wide field of view WFOV of feedback camera FC.

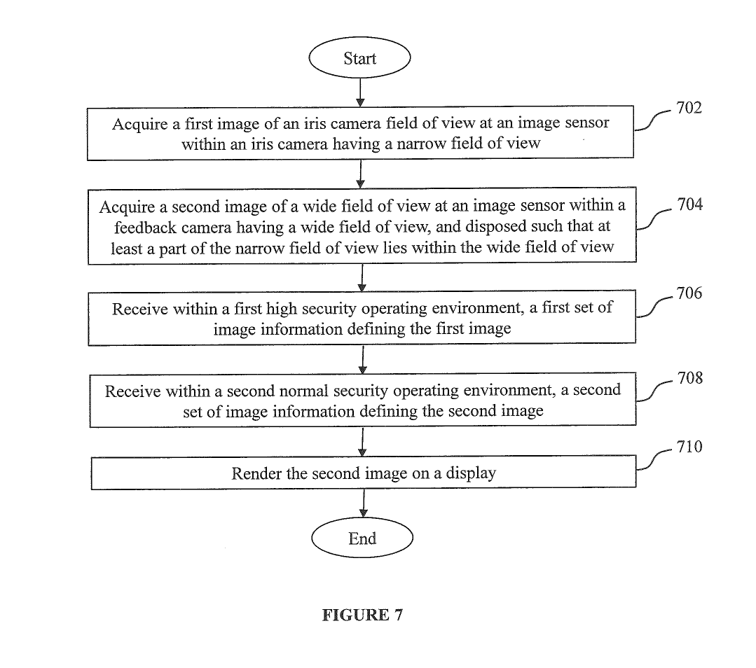

FIG. 7 illustrates a method of image acquisition and image processing that may be implemented on an imaging apparatus as illustrated in any one of FIGS. 6A or 6B.

Step 702 comprises acquiring a first image of an iris camera field of view at an image sensor within iris camera IC. As illustrated in FIGS. 6A and 6B, iris camera IC has a narrow field of view NFOV (defined by lines DE and DF). Step 704 comprises acquiring a second image of a wide field of view WFOV (defined by lines AB and AC in FIGS. 6A and 6B) at an image sensor within feedback camera FC—wherein iris camera IC and feedback camera FC are respectively configured and arranged such that at least a part of the narrow field of view NFOV corresponding to iris camera IC is located within the wide field of view WFOV corresponding to feedback camera FC.

Step 706 comprises receiving within a first high security operating environment of the image processing apparatus, a first set of information defining the first image acquired by the iris camera. At step 708, a second set of image information defining the second image acquired by the feedback camera is received within a normal security operating environment of the image processing apparatus. Step 710 thereafter comprises rendering the second image on a display.

The first image (and corresponding first set of image information) acquired by the iris camera IC is received and processed entirely within the first high security operating environment to ensure that (i) the first image of the iris camera field of view (ii) the first set of image information defining said first image of the iris camera field of view and (iii) image texture information that enables or is relevant to iris feature extraction or iris image recognition, are not communicated to or otherwise accessible outside of the first high security operating environment.

Further, since feedback camera FC is configured such that since the acquired second image excludes image texture information that enables or is relevant for iris feature extraction or iris image recognition (as discussed in connection with FIGS. 6A and 6B), sensitive image texture information remains isolated from the risk of software attacks and misappropriation threats, despite the second set of image information and the second image being exposed to the lower security offered by the normal security operating environment and/or display devices.

It would be understood that the dual camera arrangement described in FIGS. 6A to 7 may be configured to ensure that the intended region for positioning a subject's eye during iris image capture is simultaneously (or substantially simultaneously) imaged by iris camera IC and feedback camera FC. Since the iris camera IC is configured to acquire image texture information that that enables or is relevant for iris feature extraction or iris image recognition, image information acquired by the iris camera image sensor corresponding to this intended region for iris image capture is communicated to and isolated within the high security operating environment of the image processing apparatus. Since the feedback camera FC is configured to simultaneously acquire image information corresponding to the intended region for iris image capture, but which image information excludes (or omits) sensitive iris texture information, such image information may be communicated from the feedback camera to the normal security operating environment of the image processing apparatus and may be displayed to assist a subject in correctly positioning an eye relative to the iris camera IC.

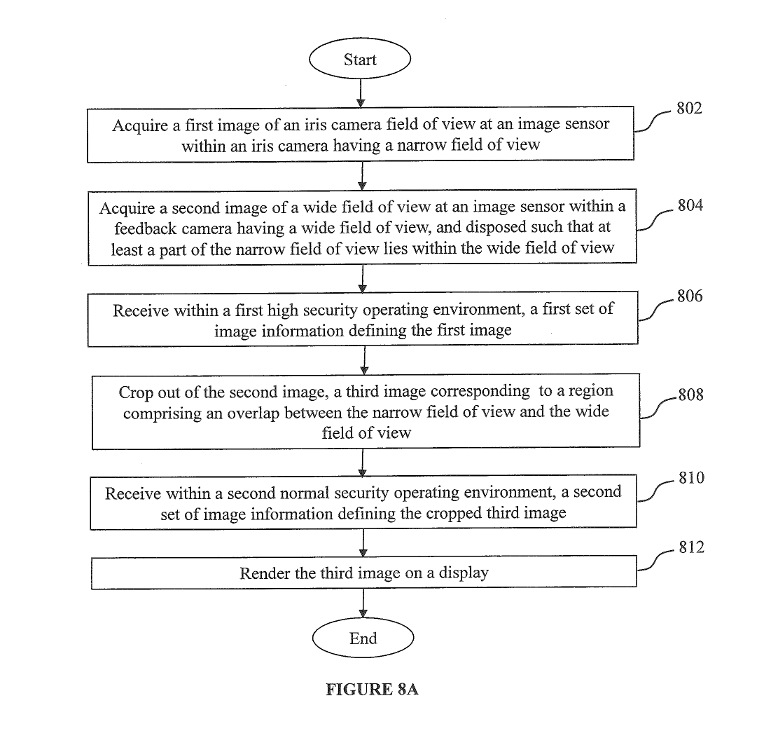

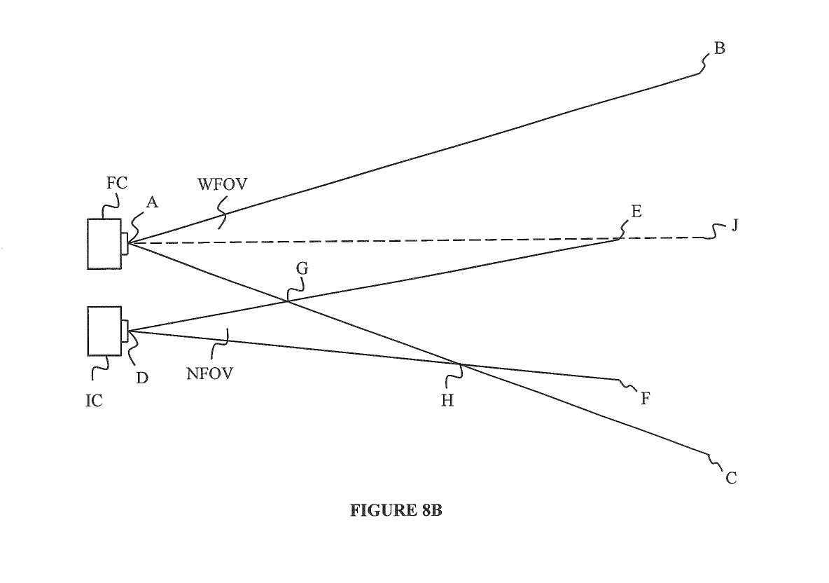

FIGS. 8A and 8B disclose preferred method and apparatus embodiments of the invention more generally discussed above in connection with FIGS. 6A, 6B and 7.

Step 802 of FIG. 8A comprises acquiring a first image of an iris camera field of view at an image sensor within iris camera IC having narrow field of view NFOV.

Step 804 comprises acquiring a second image of a wide field of view WFOV at an image sensor within feedback camera FC—wherein iris camera IC and feedback camera FC are respectively configured and arranged such that at least a part of the narrow field of view NFOV corresponding to iris camera IC is located within the wide field of view WFOV corresponding to the feedback camera FC.

Step 806 comprises receiving within a first high security operating environment of the image processing apparatus, a first set of information defining the first image acquired by the iris camera.

At step 808 a third image is cropped out of the second image, which third image includes a region comprising a part of the overlap (or the entire overlap) between the narrow field of view NFOV and the wide field of view WFOV. In the apparatus embodiment illustrated in FIG. 8B, the cropped third image corresponds to region defined by lines AJ and AC, which region includes there within the entire overlap between narrow field of view NFOV and wide field of view WFOV. Cropping of the third image out of the second image may be achieved in any number of ways and using any image cropping algorithms or functions. In an embodiment, cropping of the third image may be achieved by communicating the second image to one of the first high security operating environment and the second normal security operating environment, and subjecting it to a cropping algorithm or function. In another embodiment, cropping of the third image may be achieved by selectively parsing image sensor pixels within the feedback camera image sensor such that the resulting image is based solely on pixels corresponding to the image region defined by the overlap of narrow field of view NFOV (of iris camera IC) and wide field of view WFOV (of feedback camera FC).

At step 810, a second set of image information defining the cropped third image is received within the normal security operating environment of the image processing apparatus. Step 812 thereafter comprises rendering the cropped third image on a display.

As discussed above, the first image (and corresponding first set of image information) acquired by the iris camera IC is received and processed entirely within the first high security operating environment to ensure that (i) the first image of the iris camera field of view (ii) the first set of image information defining said first image of the iris camera field of view and (iii) image texture information that enables or is relevant to iris feature extraction or iris image recognition, are not communicated to or otherwise accessible outside of the first high security operating environment.

Since the second image acquired by feedback camera FC excludes or omits image texture information that enables or is relevant for iris feature extraction or iris image recognition, the correspondingly cropped third image also necessarily excludes or omits such image texture information. In communicating the cropped third image to the normal security operating environment and/or to a display device, sensitive image texture information therefore remains isolated from the risk of software attacks and misappropriation threats.

By displaying a cropped image corresponding to the overlap between the narrow field of view NFOV of iris camera IC and the wide field of view WFOV of feedback camera FC, the embodiment provides an operator with real time feedback regarding position of a subject's eye relative to the iris camera IC.

In embodiments of the apparatus respectively discussed in connection with FIGS. 6A to 8B where the imaging apparatus is disposed within a mobile device, iris camera IC may be a dedicated iris camera configured for iris image acquisition and having a corresponding narrow field of view NFOV, while a regular mobile device camera (such as a front facing or rear facing mobile device camera) having a wide field of view WFOV may serve as a feedback camera. It will also be understood that while the iris camera and feedback camera in FIGS. 6A to 8B have been discussed in terms of a narrow field of view and a wide field of view respectively, the inventive configurations may equally accommodate other configurations for the respective fields of view, provided there is an overlapping between the two fields of view.

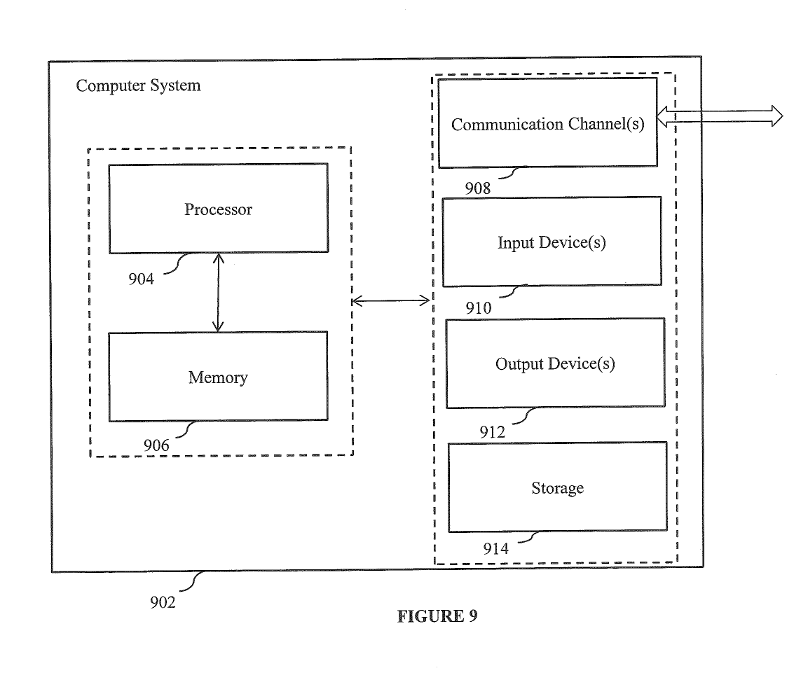

FIG. 9 illustrates an exemplary system in which various embodiments of the invention, including of the imaging apparatus, image processing apparatus and display, may be implemented.

The system 902 comprises at-least one processor 904 and at-least one memory 906. The processor 904 executes program instructions and may be a real processor. The processor 904 may also be a virtual processor. The computer system 902 is not intended to suggest any limitation as to scope of use or functionality of described embodiments. For example, the computer system 902 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 906 may store software for implementing various embodiments of the present invention. The computer system 902 may have additional components. For example, the computer system 902 includes one or more communication channels 908, one or more input devices 99, one or more output devices 912, and storage 914. An interconnection mechanism (not shown) such as a bus, controller, or network, interconnects the components of the computer system 902. In various embodiments of the present invention, operating system software (not shown) provides an operating environment for various softwares executing in the computer system 902, and manages different functionalities of the components of the computer system 902.

The communication channel(s) 908 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 99 may include, but not limited to, a touch screen, a keyboard, mouse, pen, joystick, trackball, a voice device, a scanning device, or any another device that is capable of providing input to the computer system 902. In an embodiment of the present invention, the input device(s) 99 may be a sound card or similar device that accepts audio input in analog or digital form. The output device(s) 912 may include, but not limited to, a user interface on CRT or LCD, printer, speaker, CD/DVD writer, or any other device that provides output from the computer system 902.

The storage 914 may include, but not limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 902. In various embodiments of the present invention, the storage 914 contains program instructions for implementing the described embodiments.

In an embodiment of the present invention, the computer system 902 is part of a distributed network where various embodiments of the present invention are implemented for rapidly developing end-to-end software applications.

While not illustrated in FIG. 9, the system of FIG. 9 may further include some or all of the components of an imaging apparatus of the type more fully described in connection with FIG. 3 hereinabove.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 902. The method described herein is typically implemented as a computer program product, comprising a set of program instructions which is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for secure iris image processing comprising:
acquiring a first image of a first field of view corresponding to an iris camera;
receiving at a processor implemented first high security operating environment, a first set of image information defining the first image, wherein the first set of image information includes a second sub-set of image information relevant for iris feature extraction and/or comparison;
rendering on a display, a second image of the first field of view corresponding to the iris camera;
wherein the second image is defined by a third set of image information; and
wherein the third set of information excludes the second sub-set of image information.

2. The method of claim 1, wherein the third set of information defining the second image is received at a processor implemented second normal security operating environment, for rendering the second image on the display.

3. The method of claim 2, wherein the processor implementing the first high security operating environment is configured to operate in a first security state, and the processor implementing the second normal security operating environment is configured to operate in a second security state, and wherein the first security state is more secure than the second security state.

4. The method of claim 1, wherein responsive to a part of the subject's iris being positioned within the first field of view corresponding to the iris camera, the second image rendered on the display includes an image of said part of the iris positioned within the first field of view.

5. The method of claim 1, wherein the third set of image information is generated by applying at least one image processing function to the first set of image information.

6. The method of claim 1, wherein:
the first image of the first field of view is acquired by the iris camera;
the second image is acquired by a feedback camera having a corresponding second field of view; and
at least part of the first field of view intersects at least part of the second field of view.

7. The method of claim 6, wherein intersection of the first field of view and the second field of view define an intended region for positioning of a subject's eye for optimal iris image capture.

8. The method of claim 6, wherein the first image and the second image are simultaneously acquired by the iris camera and the feedback camera respectively.

9. The method of claim 6, wherein the second field of view is wider than the first field of view.

10. The method of claim 6, wherein the iris camera has improved iris imaging characteristics in comparison to the feedback camera.

11. The method of claim 6, wherein configuration of the iris camera differs from configuration of the feedback camera in terms of at least one of pixel resolution, depth of focus, and optical filters.

12. The method of claim 6, wherein the iris camera is configured to detect image characteristics based on received wavelengths within at least one of the infrared and near infrared spectrums.

13. The method of claim 12, wherein the feedback camera includes an optical assembly comprising at least one optical filter for preventing infrared or near infrared wavelengths from being detected by an image sensor.

14. The method of claim 6, wherein intersection of the first field of view and second field of view includes a region defined by intersection of the first field of view and depth of focus of the iris camera.

15. The method of claim 1, wherein:
the first image is acquired by an iris camera having a first field of view;
the second image is generated by cropping a third image acquired by a feedback camera having a second field of view; and
wherein at least part of the first field of view intersects at least part of the second field of view.

16. The method of claim 15, wherein the cropped image includes image information corresponding to a region defined by intersection of the first field of view and the second field of view.

17. A system for secure iris image processing comprising:
an iris camera configured to acquire a first image of a first field of view corresponding to the iris camera;
a processor configured to:
implement a first high security operating environment;
receive at the first high security operating environment, a first set of image information defining the first image, wherein the first set of image information includes a second sub-set of image information relevant for iris feature extraction;
a display configured for rendering a second image of the first field of view corresponding to the iris camera;
wherein the second image is defined by a third set of image information; and
wherein the third set of information excludes the second sub-set of image information.

18. The system of claim 17, wherein the third set of information defining the second image is received at a processor configured to implement a second normal security operating environment, for rendering the second image on the display.

19. The system of claim 17, further comprising:
a feedback camera configured to have a second field of view and to acquire the second image;
wherein at least part of the first field of view intersects at least part of the second field of view.

20. The system of claim 19, wherein the iris camera and the feedback camera simultaneously acquire the first image and the second image respectively.

21. The system of claim 19, wherein the iris camera has improved iris imaging characteristics in comparison to the feedback camera.

22. The system of claim 19, wherein configuration of the iris camera differs from configuration of the feedback camera in terms of at least one of pixel resolution, depth of focus, and optical filters.

23. The system of claim 19, wherein the feedback camera includes an optical assembly comprising at least one optical filter for preventing infrared or near infrared wavelengths from being detected by an image sensor.

24. The system of claim 19, wherein intersection of the first field of view and second field of view includes a region defined by intersection of the first field of view and depth of focus of the iris camera.

25. The system of claim 17, wherein:
the processor is configured to generate the second image by cropping a third image acquired by a feedback camera having a second field of view;
and wherein at least part of the first field of view intersects at least part of the second field of view.

26. A computer program product for secure iris image processing, comprising a non-transitory computer usable medium having a computer readable program code embodied therein, the computer readable program code comprising instructions for:
acquiring a first image of a first field of view corresponding to an iris camera;
receiving at a processor implemented first high security operating environment, a first set of image information defining the first image, wherein the first set of image information includes a second sub-set of image information relevant for iris feature extraction;
rendering on a display, a second image of the first field of view corresponding to the iris camera;
wherein the second image is defined by a third set of image information; and
wherein the third set of information excludes the second sub-set of image information.
